(19) United States
(12) Patent Application Publication
(10) Pub. No.: US 2017/0236019 A1
(43) Pub. Date: Aug. 17, 2017

(54) OPTICALLY ACTIVE ARTICLES AND SYSTEMS IN WHICH THEY MAY BE USED

(71) Applicant: 3M INNOVATIVE PROPERTIES COMPANY, St. Paul, MN (US)

(72) Inventors: BENJAMIN W. WATSON, HAMPSHIRE (GB); DAVID J. McCONNELL, CHILBOLTON (GB)

(73) Assignee: 3M INNOVATIVE PROPERTIES COMPANY, St. Paul, MN (US)

(21) Appl. No.: 15/502,798

(22) PCT Filed: Aug. 3, 2015
(86) PCT No.: PCT/US15/43388

§ 371 Date: Feb. 9, 2017

Related U.S. Application Data
(60) Provisional application No. 62/036,797, filed on Aug. 13, 2014.
(60) Provisional application No. 62/192,431, filed on Jul. 14, 2015.

(51) Int. Cl. G06K 9/20; G06K 9/32

(52) U.S. Cl. CPC G06K 9/2018; G06K 9/3258; G06K 2209/15; G06K 2209/25; G06K 2209/01

(57) ABSTRACT

The inventors of the present application developed novel optically active materials, methods, and systems for reading identifying information on an optically active article. Specifically, the present application relates to substantially simultaneously capturing and/or processing a first optically active image and a second optically active image. In some embodiments, the first optically active image is taken at a first wavelength and the second optically active image is taken at a second wavelength, wherein the first wavelength is different from the second wavelength. In one aspect, the present applications relates to reading information on a license plate for purposes of vehicle identification.

### TECHNICAL FIELD

The present application relates generally to optically active articles; methods of making and using these; and systems in which the articles may be used.

### BACKGROUND

Automatic Vehicle Recognition (AVR) is a term applied to the detection and recognition of a vehicle by an electronic system. Exemplary uses for AVR include, for example, automatic tolling (e.g., electronic toll systems), traffic law enforcement (e.g., red light running systems, speed enforcement systems), searching for vehicles associated with crimes, access control systems, and facility access control. Ideal AVR systems are universal (i.e., they are able to identify a vehicle with 100% accuracy). The two main types of AVR systems in use today are (1) systems using RFID technology to read an RFID tag attached to a vehicle and (2) systems using a machine or device to read a machine-readable code attached to a vehicle.

One advantage of RFID systems is their high accuracy, which is achieved by virtue of error detection and correction information contained on the RFID tag. Using well known mathematical techniques (cyclic redundancy check, or CRC, for example), the probability that a read is accurate (or the inverse) can be determined. However, RFID systems have some disadvantages, including that not all vehicles include RFID tags. Also, existing unpowered “passive” RFID tag readers may have difficulty pinpointing the exact location of an object. Rather, they simply report the presence or absence of a tag in their field of sensitivity. Moreover, many RFID tag readers only operate at short range, function poorly in the presence of metal, and are blocked by interference when many tagged objects are present. Some of these problems can be overcome by using active RFID technology or similar methods. However, these techniques require expensive, power-consuming electronics and batteries, and they still may not determine position accurately when attached to dense or metallic objects.

Machine vision systems (often called Automated License Plate Readers or ALPR systems) use a machine or device to read a machine-readable code attached to a vehicle. In many embodiments, the machine readable code is attached to, printed on, or adjacent to a license plate. ALPR systems rely on an accurate reading of a vehicle's license plate. License plates can be challenging for an ALPR system to read due to at least some of the following factors: (1) varying reflective properties of the license plate materials; (2) non-standard fonts, characters, and designs on the license plates; (3) varying embedded security technologies in the license plates; (4) variations in the cameras or optical character recognition systems; (5) the speed of the vehicle passing the camera or optical character recognition system; (6) the volume of vehicles flowing past the cameras or optical character recognition systems; (7) the spacing of vehicles flowing past the cameras or optical character recognition systems; (8) wide variances in ambient illumination surrounding the license plates; (9) weather; (10) license plate mounting location and/or tilt; (11) wide variances in license plate graphics; (12) the detector-to-license plate-distance permissible for each automated enforcement system; and (13) occlusion of the license plate by, for example, other vehicles, dirt on the license plate, articles on the roadway, natural barriers, etc.

One advantage of ALPR systems is that they are can be used almost universally, since almost all areas of the world require that vehicles have license plates with visually identifiable (also referred to as human-readable) information thereon. However, the task of recognizing visual information can be complicated. For example, the read accuracy from an ALPR system is largely dependent on the quality of the captured image as assessed by the reader. Existing systems have difficulty distinguishing human-readable information from complex backgrounds and handling variable radiation. Further, the accuracy of ALPR systems suffers when license plates are obscured or dirty.

Because recognition of visible information on license plates can be challenging for the reasons described above, some ALPR systems include machine-readable information (e.g. a barcode) containing or relating to information about the vehicle in addition to the human-readable information. In some instances, the barcode on a license plate includes inventory control information (i.e., a small barcode not intended to be read by the ALPR). Some publications (e.g., European Patent Publication No. 0416742 and U.S. Pat. No. 6,832,728) discuss including one or more of owner information, serial numbers, vehicle type, vehicle weight, plate number, state, plate type, and county on a machine-readable portion of a license plate. PCT Patent Publication No. WO 2013-149142 describes a license plate with a barcode wherein framing and variable information are obtained under two different conditions. In some embodiments, the framing information is provided by human-readable information, and variable information is provided by machine-readable information. European Patent Publication No. 0416742, U.S. Pat. No. 6,832,728, and PCT Patent Publication No. WO 2013-149142 are all incorporated in their entirety herein.

Some prior art methods of creating high contrast license plates for use in ALPR systems involve including materials that absorb in the infra-red wavelength range and transmit in the visible wavelength range. For example, U.S. Pat. No. 6,832,728 (the entirety of which is hereby incorporated herein) describes license plates including visible transmissive, infra-red opaque indicia. U.S. Pat. No. 7,387,393 describes license plates including infra-red blocking materials that create contrast on the license plate. U.S. Pat. No. 3,758,193 describes infra-red transmissive, visible absorptive materials for use on retroreflective sheeting. The entirety of U.S. Pat. Nos. 6,832,728 and 3,758,193 and U.S. Pat. No. 7,387,393 are hereby incorporated herein.

Another prior art method of creating high contrast license plates for use in ALPR systems is described in U.S. Pat. No. 8,865,293 and involves positioning an infrared-reflecting material adjacent to an optically active (e.g., reflective or retroreflective) substrate such that the infrared-reflecting material forms a pattern that can be read by an infrared sensor when the optically active substrate is illuminated by an infrared radiation source. The entirety of U.S. Pat. No. 8,865,293 is incorporated herein by reference.

Another prior art method of creating high contrast license plates for use in ALPR systems involves inclusion of a radiation scattering material on at least a portion of retroreflective sheeting. As is described in U.S. Patent Publication No. 2012/0195470 (the entirety of which is hereby incorporated herein), the radiation scattering material reduces the brightness of the retroreflective sheeting without substantially changing the appearance of the retroreflective sheeting when viewed under scattered radiation, thereby creating a high contrast, wavelength independent, retroreflective sheeting that can be used in a license plate.

### SUMMARY

Many optically active articles (such as license plates) include two types of identifying information (referred to generally as first and second identifying information, or sets or types of identifying information). In some instances, one set (also referred to as first set) of identifying information is human-readable (e.g. alphanumeric plate identification information) and the other set (also referred to as additional or second set) of identifying information is machine-readable (e.g., a barcode). In some instances, the first and second sets or types of identifying information occupy at least some of the same area on the optically active article. In some instances, the first and second sets of identifying information physically overlap.

Many ALPR cameras detect or read the alphanumeric identifying information on the optically active article by irradiating the optically active article with radiation having a wavelength in the near infrared (“near IR”) range (e.g. at or above 750 nm). Alternatively, some cameras detect or read the alphanumeric identifying information on the optically active article by irradiating the optically active article with radiation having a wavelength in the visible spectrum (e.g., from about 390 nm to about 700 nm).

The inventors of the present disclosure sought to make identification and authentication of optically active articles easier and/or to improve the identification accuracy of optically active articles. In another aspect, the present inventors sought to make identification of license plates easier and/or to improve the identification accuracy of license plate indicia information. The inventors of the present disclosure also recognized that substantially simultaneously generating images of an optically active article under at least two different conditions would improve read rate and detection of the optically active article. The present inventors also sought to improve readability and accuracy of reading information on an optically active article when the information to be read at least partially overlap (i.e., are located within at least a portion of the same physical image space). In some embodiments, the two conditions are two different wavelengths.

The inventors recognized that one exemplary solution to these issues was to provide a system for reading an optically active article comprising: an optically active article including a first set of identifying information and a second set of identifying information, wherein the first set is detectable at a condition (e.g., first wavelength) and the second set is detectable at a second condition (e.g., second wavelength, different from the first wavelength); and an apparatus for substantially concurrently processing the first and second set of identifying information. In some embodiments, the apparatus further includes a first sensor and a second sensor. In some embodiments, the first sensor detects at the first wavelength and the second sensor detects at the second wavelength. In some embodiments the first wavelength is within the visible spectrum and the second wavelength is within the near infrared spectrum. In other embodiments the first wavelength and the second wavelength are within the near infrared spectrum. In some embodiments, the first sensor substantially concurrently produces a first image as illuminated by the first wavelength (at the first wavelength) and the second sensor produces a second image as illuminated by the second wavelength (at the second wavelength).

In some embodiments the first set of identifying information is non-interfering in the second wavelength. In some embodiments, the second set of identifying information is non-interfering in the first wavelength. In some embodiments, the first set of identifying information is human-readable. In some embodiments, the second set of identifying information is machine-readable. In some embodiments the first set of identifying information includes at least one of alphanumerics, graphics, and symbols. In some embodiments, the second set of identifying information includes at least one of alphanumerics, graphics, symbols, and a barcode. In some embodiments, the first set of identifying information at least partially overlaps with the second set of identifying information.

In some embodiments, the optically active article is reflective or retroreflective. In some embodiments, the optically active article is at least one of a license plate or signage. In some embodiments, the reflective article is non-retroreflective

In some embodiments, the apparatus includes a first source of radiation and a second source of radiation. In some embodiments, the first source of radiation emits radiation in the visible spectrum, and the second source of radiation emits radiation in the near infrared spectrum. In other embodiments, the first source of radiation and the second source of radiation emit radiation in the near infrared spectrum.

In some embodiments, the apparatus includes a first lens and a second lens.

In another aspect, the present application relates to a method of reading identifying information comprising: substantially simultaneously exposing an optically active article to a first condition and a second condition, different from the first condition, and substantially concurrently capturing a first optically active article image at the first condition and a second optically active article image at the second condition. In some embodiments, the first condition is radiation having a first wavelength and the second condition is radiation having a second wavelength, the second wavelength being different from the first wavelength. In some embodiments, the first optically active article image is captured within 40 milliseconds or less from the capturing of the second optically active article image. In other embodiments, the first optically active article image is captured within 20 milliseconds or less, 10 milliseconds or less, or 5 milliseconds or less from the capturing of the second optically active article image. In some embodiments, the first optically active article image is captured within about 1 millisecond or less from the capturing of the second optically active article image.

In yet another aspect, the present application relates to an apparatus for reading an optically active article comprising: a first channel detecting at a first condition; a second channel detecting at a second condition; wherein the apparatus substantially concurrently captures at least a first image through the first channel and a second image through the second channel.

In some embodiments, the apparatus further comprises a third channel detecting at a third condition. In some embodiments, at least one of the images is colored as illuminated by a broad spectrum radiation.

### BRIEF DESCRIPTION OF THE DRAWINGS

FIG. 1 is a block diagram illustrating an exemplary processing sequence according to the present application.

### DETAILED DESCRIPTION

Various embodiments and implementations will be described in detail. These embodiments should not be construed as limiting the scope of the present disclosure in any manner, and changes and modifications may be made without departing from the spirit and scope of the inventions. Further, only some end uses have been discussed herein, but end uses not specifically described herein are included within the scope of the present disclosure. As such, the scope of the present disclosure should be determined only by the claims.

As used herein, the term “infrared” refers to electromagnetic radiation with longer wavelengths than those of visible radiation, extending from the nominal red edge of the visible spectrum at around 700 nanometers (nm) to over 1000 nm. It is recognized that the infrared spectrum extends beyond this value. The term “near infrared” as used herein refers to electromagnetic radiation with wavelengths between 700 nm and 1300 nm.

As used herein, the term “visible spectrum” or “visible” refers to the portion of the electromagnetic spectrum that is visible to (i.e., can be detected by) the human eye. A typical human eye will respond to wavelengths from about 390 to 700 nm.

As used herein, the term “substantially visible” refers to the property of being discernible to most humans' naked eye when viewed at a distance of greater than 10 meters. (i.e., an observer can identify, with repeatable results, a sample with a unique marking from a group without the marking.) For purposes of clarity, “substantially visible” information can be seen by a human's naked eye when viewed either unaided and/or through a machine (e.g., by using a camera, or in a printed or onscreen printout of a photograph taken at any wavelength of radiation) provided that no magnification is used.

As used herein, the term “substantially invisible” refers to the property of being not “substantially visible,” as defined above. For purposes of clarity, substantially invisible information cannot be seen by a human's naked eye when viewed by the naked eye and/or through a machine without magnification at a distance of greater than 10 meters.

As used herein, the term “detectable” refers to the ability of a machine vision system to extract a piece of information from an image through the use of standard image processing techniques such as, but not limited to, thresholding.

As used herein, the term “non-interfering” means that information will not interfere with the extraction of other information that may overlap with the information to be extracted.

As used herein, the term “overlap” means that at least a portion of the first set of information and at least a portion of the second set of information occupy at least a portion of the same physical image space.

As used herein, the term “optically active” with reference to an article refers to an article that is at least one of reflective (e.g., aluminum plates), non-retroreflective or retroreflective.

The term “retroreflective” as used herein refers to the attribute of reflecting an obliquely incident radiation ray in a direction generally antiparallel to its incident direction such that it returns to the radiation source or the immediate vicinity thereof.

As used herein, the term “human-readable information” refers to information and/or data that is capable of being processed and/or understood by a human with 20/20 vision without the aid or assistance of a machine or other processing device. For example, a human can process (e.g., read) alphanumerics or graphics because a human can process and understand the message or data conveyed by these types of visual information. As such, alphanumerics (e.g., written text and license place alphanumerics) and graphics are two non-limiting examples of types of information considered to be human-readable information as defined here.

As used herein, the term “machine-readable information” refers to information and/or data that cannot be processed and/or understood without the use or assistance of a machine or mechanical device. For example, even though a human can detect the visual presence of the vertical stripes that visually represent a barcode, a human cannot generally process and understand the information coded into a barcode without the use or assistance of a machine or mechanical device. As such, a barcode (e.g., 1D barcodes as used in retail stores and 2D QR barcodes) is one non-limiting example of machine-readable information as defined herein. In contrast, as described above, alphanumerics and graphics are two non-limiting examples of types of information considered not to be machine-readable information as defined herein.

As used herein, the term “set” with respect to identifying information can include one or more individual pieces or portions.

As used herein, the terms “substantially simultaneous” and “substantially concurrent” may be used interchangeably, and refer to carrying out at least two actions with a maximum time difference between the actions of 40 milliseconds (ms). In some embodiments, the actions are performed within 1 ms of each other. In some embodiments, images of adjacent capture channels are captured substantially simultaneously, that is, captured in a time frame that would enable their logical assignment to an event of interest from the real world.

In one aspect, the present application relates to a system for reading identifying information comprising: an optically active article including a first set of identifying information and a second set of identifying information, wherein the first set is detectable at a first condition and the second set is detectable at a second condition, different from the first condition; and an apparatus for substantially concurrently processing the first and second set of identifying information. In some embodiments, the first condition is a first wavelength (e.g., within the visible spectrum) and the second condition is a second wavelength, different from the first wavelength (e.g., within the infrared spectrum).

In some embodiments, the identifying information (first set and/or second set of identifying information) is human-readable information. In some embodiments, the identifying information is an alphanumeric plate identifier. In some embodiments, the identifying information includes alphanumerics, graphics, and/or symbols. In some embodiments, the identifying information is formed from or includes at least one of an ink, a dye, a thermal transfer ribbon, a colorant, a pigment, and/or an adhesive coated film.

In some embodiments, the identifying information is machine-readable (first set and/or second set of identifying information) and includes at least one of a barcode, alphanumerics, graphics, symbols, and/or adhesive-coated films. In some embodiments, the identifying information is formed from or includes a multi-layer optical film, a material including an optically active pigment or dye, or an optically active pigment or dye.

In some embodiments, the identifying information is detectable at a first wavelength and non-interfering at a second wavelength, the second wavelength being different from the first wavelength. In some embodiments, the first identifying information is detectable at a wavelength within the visible spectrum and non-interfering at a wavelength within the near infrared spectrum. In some embodiments, the second identifying information is non-interfering at a wavelength within the visible spectrum and detectable at a wavelength within the near infrared spectrum.

In some embodiments, the identifying information is substantially visible at a first wavelength and substantially invisible at a second wavelength, the second wavelength being different from the first wavelength. In some embodiments, the first identifying information is substantially visible at a wavelength within the visible spectrum and substantially invisible and/or non-interfering at a wavelength in the near infrared spectrum. In some embodiments, the second identifying information is substantially invisible and/or non-interfering at a wavelength within the visible spectrum and detectable at a wavelength within the near infrared spectrum.

In some embodiments, the first identifying information and/or the second identifying information forms a security mark (security marking) or secure credential. In some embodiments, the terms “security mark” and “secure credential” may be used interchangeably and refer to indicia assigned to assure authenticity, defend against counterfeiting or provide traceability. In some embodiments, the security mark is machine readable and/or represents data. Security marks are preferably difficult to copy by hand and/or by machine, or are manufactured using secure and/or difficult to obtain materials. Optically active articles with security markings may be used in a variety of applications such as securing tamperproof images in security documents, passports, identification cards, financial transaction cards (e.g., credit cards), license plates, or other signage. The security mark can be any useful mark including a shape, figure, symbol, QR code, design, letter, number, alphanumeric character, and indicia, for example. In some embodiments, the security marks may be used as identifying indicia, allowing the end user to identify, for example, the manufacturer and/or lot number of the optically active article.

In some embodiments, the first identifying information and/or the second identifying information forms a pattern that is discernible at different viewing conditions (e.g., illumination conditions, observation angle, entrance angle). In some embodiments, such patterns may be used as security marks or secure credentials. These security marks can change appearance to a viewer as the viewer changes illumination conditions and /or their point of view of the security mark.

In some embodiments, the optically active article is one of reflective, non-retroreflective or retroreflective. In some embodiments, the retroreflective article is a retroreflective sheeting. The retroreflective sheeting can be either microsphere-based sheeting (often referred to as beaded sheeting) or cube corner sheeting (often referred to as prismatic sheeting). Illustrative examples of microsphere-based sheeting are described in, for example, U.S. Pat. No. 3,190,178 (McKenzie), U.S. Pat. No. 4,025,159 (McGrath), and U.S. Pat. No. 5,066,098 (Kult). Illustrative examples of cube corner sheeting are described in, for example, U.S. Pat. No. 1,591,572 (Stimson), U.S. Pat. No. 4,588,258 (Hoopman), U.S. Pat. No. 4,775,219 (Appledorn et al.), U.S. Pat. No. 5,138,488 (Szczech), and U.S. Pat. No. 5,557,836 (Smith et al.). A seal layer may be applied to the structured cube corner sheeting surface to keep contaminants away from individual cube corners. Flexible cube corner sheetings, such as those described, for example, in U.S. Pat. No. 5,450,235 (Smith et al.) can also be incorporated in embodiments or implementations of the present disclosure. Retroreflective sheeting for use in connection with the present disclosure can be, for example, either matte or glossy.

The optically active article or retroreflective sheeting can be used for, for example, as signage. The term “signage” as used herein refers to an article that conveys information, usually by means of alphanumeric characters, symbols, graphics, or other indicia. Specific signage examples include, but are not limited to, signage used for traffic control purposes, street signs, identification materials (e.g., licenses), and vehicle license plates.

Exemplary methods and systems for reading an optically active article of for reading identifying information on an optically active article include an apparatus and at least one source of radiation. The present apparatus substantially concurrently captures at least two images of the optically active article under two different conditions. In some embodiments, the different conditions include different wavelengths. In some embodiments, the apparatus of the present application is capable of substantially concurrently capturing at least a first image of the optically active article at a first wavelength, and a second image of the optically active article at a second wavelength, the second wavelength being different from the first wavelength. In some embodiments, the first and second images are taken within a time interval of less than 40 milliseconds (ms). In other embodiments, the time interval is less than 20 ms, less than 5 ms, or less than 1 ms.

In some embodiments, the apparatus of the present application is a camera. In some embodiments, the camera includes two sensors detecting at two wavelengths. In some embodiments, the first and second sensors substantially concurrently detect the first and second wavelengths.

In some embodiments, the camera includes a first source of radiation and a second source of radiation. In some embodiments, the first source of radiation emits radiation in the visible spectrum, and the second source of radiation emits radiation in the near infrared spectrum. In other embodiments, the first source of radiation and the second source of radiation emit radiation in the near infrared spectrum.

In some embodiments, the camera includes a first lens and a second lens.

In some embodiments, the present camera captures frames at 50 frames per second (fps). Other exemplary frame capture rates include 60, 30 and 25 fps. It should be apparent to a skilled artisan that frame capture rates are dependent on application and different rates may be used, such as, for example, 100 or 200 fps. Factors that affect required frame rate are, for example, application (e.g., parking vs, tolling), vertical field of view (e.g., lower frame rates can be used for larger fields of view, but depth of focus can be a problem), and vehicle speed (faster traffic requires a higher frame rate).

In some embodiments, the present camera includes at least two channels. In some embodiments, the channels are optical channels. In some embodiments, the two optical channels pass through one lens onto a single sensor. In one embodiment, the present camera includes at least one sensor, one lens and one band pass filter per channel. In some embodiments, the band pass filter permits the transmission of multiple near infrared wavelengths to be received by the single sensor.

The at least two channels may be differentiated by one of the following: (a) width of band (e.g., narrowband or wideband, wherein narrowband illumination may be any wavelength from the visible into the near infrared); (b) different wavelengths (e.g., narrowband processing at different wavelengths can be used to enhance features of interest, such as, for example, a license plate and its lettering (license plate identifier), while suppressing other features (e.g., other objects, sunlight, headlights); (c) wavelength region (e.g., broadband light in the visible spectrum and used with either color or monochrome sensors); (d) sensor type or characteristics; (e) time exposure; and (f) optical components (e.g., lensing).

In some embodiments, the channels may follow separate logical paths through the system.

In some embodiments, the camera further comprises a third channel detecting at a third wavelength.

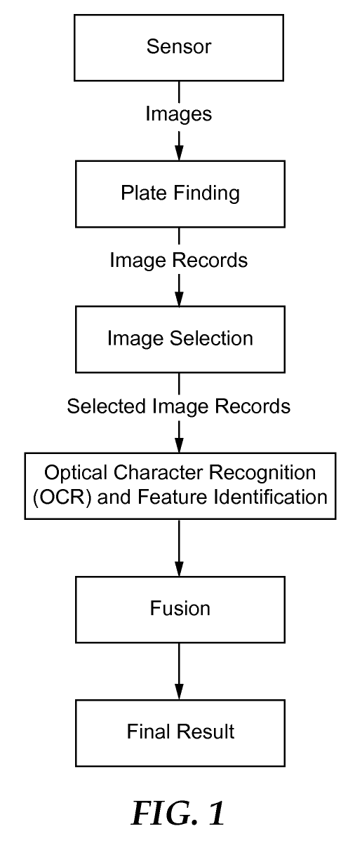

FIG. 1 is a block diagram illustrating an exemplary processing sequence of a single channel according to the present application. In the process shown in FIG. 1, the present apparatus captures images of an object of interest (e.g., a license plate). These images are processed and the license plate detected on the images through a plate-find process (plate finding). One advantage of the present apparatus relates to being able to use data gleaned from a first channel to facilitate processing on a second channel. An exemplary embodiment of such method includes a first channel and a second channel, wherein the first channel is a narrowband infrared channel (illuminated on-axis) and the second channel is a color channel (illuminated off-axis). If the object of interest is, for example, a retroreflective license plate, the first channel would produce good quality plate find information due to the on-axis illumination, while images captured through the second channel would require additional processing. Information obtained from the first channel (e.g., license plate location on an image) can then be used to help with the additional processing for the second channel.

In an alternate embodiment, data gleaned from the second channel (color channel, illuminated off-axis) may be used to facilitate processing on the first channel (narrowband infrared channel, illuminated on-axis).

In some embodiments, the presently disclosed systems and method are useful when capturing images of a plurality of different optically active articles that are simultaneously present, including, but not limited to, non-retroreflective articles and retroreflective articles, and articles that have colored and/or wavelength-dependent indicia. In these embodiments, the first channel may be used to read one article and the second channel may be used to read the second, different, article. In one embodiment, retroreflective articles and non-retroreflective articles are present. In this embodiment, the retroreflective articles may be detected and read by the first channel (e.g., a narrowband infrared channel) while the non-retroreflective articles are only readable by the second channel (e.g., color channel).

In another embodiment, the optically active article comprises a colored indicia and/or a wavelength-selective indicia. Colored indicia are only detectable by a color channel and not by an infrared channel. The wavelength-selective indicia include, for example, visibly-opaque, visibly-transmissive, infrared-transmissive and/or infrared-opaque materials. Infrared-opaque materials are those materials detectable under infrared radiation and may be infrared-absorbing, infrared-scattering or infrared reflecting. In one embodiment, the wavelength-selective indicia includes a visibly transparent, infrared-reflecting material as described in U.S. Pat. No. 8,865,293, the disclosure of which is incorporated herein by reference in its entirety. In another embodiment, the wavelength-selective indicia includes a visibly-opaque, infrared-transparent material, such as, for example disclosed in Patent Publication No. 2015/0060551, the disclosure of which is incorporated herein by reference in its entirety.

In some embodiments, the present systems and methods may be used to differentiate confusing features, for example, a mounting bolt versus an infrared-opaque indicia on a license plate. In this embodiment, the bolt and indicia will appear dark to a first infrared channel, however they will be clearly distinguishable on an image taken through a color channel, for example.

The captured images from each channel are then submitted to optical character recognition (OCR) by an OCR engine, and this may be a CPU-time consuming step. Specifically, due to CPU resource limitations and/or high rate of image capture, the system may not be able to perform OCR on every captured image. Some form of prioritized selection is required. One advantage of the present systems and apparatus is that selection criteria may be used to identify candidate images most likely to contain readable plates. These candidate images are then prioritized for submission to the OCR engine. An image selection process step maintains a time ordered queue of candidate image records (each image record contains image metadata, including, for example, plate-find data). This queue has a limited length. As new image records arrive from the channels, they are evaluated against those image records already in the queue. If the new image record is deemed “better” than any already in the queue, or if the queue is not full, the new image record joins the back of the queue. If the queue is “full”, the weakest candidate currently in the queue is removed. In some embodiments, the image selection queue is maintained separately on each channel.

In some embodiments image metadata (such as plate-find information) from one channel may be used to guide the image selection process on another channel.

In the OCR and feature identification step, the image records are removed from the front of the selector queue and OCR is performed on the underlying images. OCR is normally performed on the parts of the image where the plate find step indicated a license plate may be. If a result is not obtained (e.g., a license plate is not found on the image), the full image may then be processed by the OCR engine.

In some embodiments the OCR and feature identification step is performed separately for each channel.

Once images from the at least two channels have been processed, a final result is obtained containing at least one image and bundles of data (e.g., including date, time, images, barcode read data, OCR read data, and other metadata). In some embodiments, the present apparatus and systems use a process step referred to as fusion. The fusion process step includes at least one fusion module and at least one fusion buffer. In some embodiments, the fusion module collects consecutive read results from each channel (or sensor), and processes these read results to determine consensus on an intra-channel (one channel), or inter-channel basis.

The fusion buffer accumulates incoming read results (and associated metadata thereof) until such time as it determines that the vehicle transit is complete. At this point, the fusion buffer generates an event containing all the relevant data to be delivered to a back office. In some embodiments, the accumulated data of a specific vehicle transit is discarded after being sent to the back office.

In some embodiments, the fusion module performs other value-adding tasks. In one embodiment, a value-add task includes one of color and/or state recognition performed on a first channel (e.g., color channel). This recognition helps a second channel (e.g., infrared) with its optical character recognition process. Specifically, because the second channel would already have some information about origin of the license plate (provided by the information gleaned from the first channel), the second channel's OCR could apply, for example, syntax rules that are specific to the identified state when reading the plate identifier information (e.g. alphanumeric characters).

In another exemplary embodiment, a value-add task is detecting conflict and adjusting read confidence accordingly. For example, a license plate having the character ‘0’ (zero) and an infrared-opaque bolt positioned in the middle of the zero, could be misread as an ‘8’ under infrared conditions by the second (infrared) channel. However, the first (color) channel would be able to distinguish the bolt from the character zero and read it correctly. In these circumstances, the system may not be able to decide by itself which read is correct, but it will flag it as a discrepant event for further review.

Similarly to the embodiments described above, someone may intentionally try to confuse the OCR engine by, for example, mounting a bolt, strategically positioning strips of adhesive tape, or painting part of the characters. With the methods described herein, these attempts would be identified as discrepant reads in the first and second channels, which would then lead to further review of the captured images.

Further, being able to detect color of the plate may help confirm special status plates (e.g., government, diplomatic, commercial) and jurisdictions where front plates are one color and rear plates are a different color, such as, for example, in the UK where front plates are white and rear plates are yellow.

In one embodiment, the present systems and methods may be useful in differentiating

European-style “Hazardous Goods” panels (also referred to as “Hazard Plates”). These plates are retroreflective and orange in color. Detecting blank Hazard Plates under infrared conditions is difficult as they simply appear as a bright rectangle. As such, any other light colored rectangular area (including even large headlights) could be misidentified as a blank Hazard Plate, leading to a “false positive” read. This is particularly problematic if we consider that only maybe 1 in 1000 vehicles have a blank Hazard Plate. If, in addition, 1 in 1000 other vehicles triggers a false positive, then 50% of the reported blank Hazard Plates are actually false positives. The ability of the present method of identifying the color of the plate in addition to detection under infrared conditions largely eliminates these false positives.

It should be apparent to a skilled artisan that even though the embodiments described above include two channels, the same inventive concepts and benefits may be applied to three or more channels. These embodiments are also included within the scope of the present disclosure.

In some embodiments, at least one of the images is colored as illuminated by a broad spectrum radiation.

In some embodiments, the present apparatus further comprises at least one single core computer processing unit (CPU). In some embodiments, the CPU is co-located with a camera, that is, disposed within close proximity to the camera. In some embodiments, the CPU is mounted on the same board as the camera. In other embodiments, the CPU is not co-located with the camera and is connected to the camera by other means of communication, such as, for example, coaxial cables and/or wireless connections. In some embodiments, the CPU substantially concurrently processes multiple frames via operating system provided services, such as, for example, time slicing and scheduling. In other embodiments, the apparatus further comprises at least one multi-core CPU.

The presently described apparatus and systems produce bundles of data including, for example, date, time, images, barcode read data, OCR read data, and other metadata, that may be useful in vehicle identification for, for example, parking, tolling and public safety applications.

In some embodiments, the present system captures information for at least one vehicle. In some embodiments, this is accomplished by reading multiple sets of information on an optically active article (e.g., license plate). In some embodiments, the system captures information related to the vehicle transit. Any vehicle transit normally involves generating and processing dozens of images per channel. This is important as the camera performs automatic exposure bracketing, such that more than one single image is needed to cover different exposures. In addition, multiple reads are required as the license plate position and exposure change from frame to frame.

In some embodiments, pre-processing is needed to increase speed rate. In some embodiments, intelligent selection is performed via field-programmable gate array (FPGA) pre-processing which can process multiple channels at 50 fps. For example, during one vehicle transit, (hypothetically) fifteen images may be processed by OCR from a first channel, but only three barcode images from a second channel may be processed during the same period. This difference in the number of images processed per channel may happen when one of the images (e.g., barcode image) is more complex.

The images of the optically active article may be captured at ambient radiation and/or under radiation conditions added by a designated radiation source (for example, coaxial radiation that directs radiation rays onto the optically active article when the camera is preparing to record an image). The radiation rays emitted by the coaxial radiation in combination with the reflective or retroreflective properties of the optically active article create a strong, bright signal coincident with the location of the optically active article in an otherwise large image scene. The bright signal may be used to identify the location of the optically active article. Then, the method and/or system for reading the optically active articles focuses on the region of interest (the region of brightness) and searches for matches to expected indicia or identifying information by looking for recognizable patterns of contrast. The recognized indicia or identifying information are often provided with some assessment of the confidence in the match to another computer or other communication device for dispatching the information about the observed optically active article.

The radiation detected by the camera can come from any of a number of sources. Of particular interest is the radiation reflected from the optically active article, and specifically, the amount of radiation reflected from each area inside that region of interest on the article. The camera or detection system collects radiation from each region of the optically active article with the goal of creating a difference (contrast) between the background and/or between each indicia or piece of identifying information on the optically active article. Contrast can be effected in numerous ways, including the use of coaxial radiation to overwhelm the amount of ambient radiation. The use of filters on the camera can help accentuate the differences between the indicia or identifying information and background by selectively removing undesired radiation wavelengths and passing only the desired radiation wavelengths.

In some embodiments, the optically active article is one of a license plate or signage. Typically, useful wavelengths of radiation at which to capture images of optically active articles are divided into the following spectral regions: visible and near infrared. Typical cameras include sensors that are sensitive to both of these ranges, although the sensitivity of a standard camera system decreases significantly for wavelengths longer than 1100nm. Various radiation (or light) emitting diodes (LEDs) can emit radiation over the entire visible and near infrared spectra range, and typically most LEDs are characterized by a central wavelength and a narrow distribution around that central wavelength. Alternatively, multiple radiation sources (e.g., LEDs) may be used.

The cameras and radiation sources for the systems of the present application are typically mounted to view, for example, license plates at some angle to the direction of vehicle motion. Exemplary mounting locations include positions above the traffic flow or from the side of the roadway. Images are typically collected at an incidence angle of between about 10 degrees to about 60 degrees from normal incidence (head-on) to the license plate. In some embodiments, the images are collected at an incidence angle of between about 20 degrees to about 45 degrees from normal incidence (head-on) to the license plate. Some exemplary preferred angles include, for example, 30 degrees, 40 degrees, and 45 degrees.

A sensor (detector) which is sensitive to infrared or ultraviolet radiation as appropriate would be used to detect retroreflected radiation outside of the visible spectrum. Exemplary commercially available cameras include but are not limited to the P372, P382, and P492 cameras sold by 3M Company.

In another aspect, the present application relates to an apparatus for reading an optically active article comprising: a first channel capable of detecting at a first wavelength; and a second channel capable detecting at a second wavelength; wherein the apparatus substantially concurrently captures at least a first image through the first channel and a second image through the second channel. In some embodiments, the first and second wavelengths are within the visible spectrum. In other embodiments, the first wavelength is within the visible spectrum and the second wavelength is within the near infrared spectrum. In some embodiments, at least of the images captured by the present apparatus is a color image of the optically active article.

In some embodiments, the present apparatus further includes a third channel capable of detecting at a third wavelength and capable of producing a third image of the optically active article through the third channel. In some embodiments, the first, second and third wavelengths are all different from each other.

The articles, including optically active sheeting and license plates, described herein can be used to improve the capture efficiency of these license plate detection or recognition systems. Capture efficiency can be described as the process of correctly locating and identifying license plate data, including, but not limited to, indicia, plate type, and plate origin. Applications for these automated systems include, but are not limited to, electronic toll systems, red radiation running systems, speed enforcement systems, vehicle tracking systems, trip timing systems, automated identification and alerting systems, and vehicle access control systems. As is mentioned above, current automatic license plate recognition systems have capture efficiencies that are lower than desired due to, for example, low or inconsistent contrast of identifying information as well as obscuring (because of, for example, overlapping) identifying information on the license plate.

In some embodiments, the present system and apparatus are used to read identifying information on a license plate, such as, for example, a barcode and a license plate identifier (alphanumerics). In some embodiments, the barcode is designed such that it becomes visible at a particular infrared wavelength. An exemplary barcode is described in U.S. Patent Publication No. 2010-0151213, the disclosure of which is incorporated herein by reference. In this embodiment, it is possible to read both the barcode and license plate identifier simultaneously but on different channels. The barcode reading channel would be a narrowband infrared channel (e.g. 950 nm). The second channel would be one of a narrowband IR, a narrowband visible or full visible channel.

In some embodiments, the license plate identifier is detectable in the visible spectrum and non-interfering in the near infrared spectrum. In this embodiment, the plate-find information obtained from the barcode reading channel would assist in locating the plate in the image captured by the second channel, wherein the second channel is in the visible spectrum.

In another embodiment, the present systems and apparatus may be used to identify symbols, logos or other indicia on a license plate. License plates often have indicia such as illustrations, symbols, logos and supplementary lettering. The transparency of these indicia may vary with infrared wavelength. The multi-channel apparatus of the present application may be used to selectively suppress or enhance information on a license plate. For example, the license plate to be read may include a logo as part of the background. In some instances, the logo may overlap with the license plate identifier to be read. In order to accurately read the license plate identifier it may be necessary use a first sensor or channel detecting at a wavelength at which the logo is transparent, or non-interfering. A second sensor or channel is then selected to detect at a wavelength at which the logo is visible. Images of the logo captured by the second sensor/channel may be used to assist in identifying, for example, issuing authority or year of issue of the license plate. The images captured at the different wavelengths are substantially simultaneously captured or processed to yield a final image containing a bundle of data.

Those having skill in the art will appreciate that many changes may be made to the details of the above-described embodiments and implementations without departing from the underlying principles thereof. The scope of the present disclosure should, therefore, be determined only by the following claims.

1. A system for reading identifying information comprising:
an optically active article including a first set of identifying information and a second set of identifying information, wherein the first set is detectable at a first wavelength and the second set is detectable at a second wavelength, different from the first wavelength; and
an apparatus for substantially concurrently processing the first and second set of identifying information.

2. The system of claim 1, wherein the apparatus further includes a first sensor and a second sensor, the first sensor detecting at the first wavelength and the second sensor detecting at the second wavelength.

3. The system of claim 1, wherein the first wavelength is within the visible spectrum and the second wavelength is within the near infrared spectrum.

4. (canceled)

5. The system of claim 1, wherein the first set of identifying information is non-interfering in the second wavelength, and the second set of identifying information is non-interfering in the first wavelength.

6. (canceled)

7. The system of claim 1, wherein the first set of identifying information is human-readable, and the second set of identifying information is machine-readable.

8-10. (canceled)

11. The system of claim 1, wherein the optically active article is non-retroreflective or retroreflective.

12. The system of claim 1, wherein the optically active article is at least one of a license plate or signage.

13-17. (canceled)

18. The system of claim 2, wherein the first sensor concurrently produces a first image as illuminated by the first wavelength and the second sensor produces a second image as illuminated by the second wavelength.

19. The system of claim 1, wherein the first set of identifying information is processed within 40 milliseconds or less from the processing of the second set of identifying information.

20-21. (canceled)

22. A method of reading an optically active article comprising:
substantially simultaneously exposing an optically active article to radiation having a first wavelength and radiation having a second wavelength, the second wavelength being different from the first wavelength; and
substantially concurrently capturing a first optically active article image at the first wavelength and a second optically active article image at the second wavelength.

23. The method of claim 22, wherein the optically active article comprises first identifying information and second identifying information, wherein the first identifying information is substantially visible at the first wavelength and non-interfering in the second wavelength, and the second identifying information is not substantially visible at the first wavelength and is detectable in the second wavelength.

24-25. (canceled)

26. The method of claim 22, wherein the optically active article is non-retroreflective or retroreflective.

27-29. (canceled)

30. The method of claim 22, further comprising:
performing optical character recognition of at least one of the first identifying information and the second identifying information.

31. The method of claim 22, wherein the first optically active article image is captured within 40 milliseconds or less from the capturing of the second optically active article image.

32-33. (canceled)

34. An apparatus for reading an optically active article comprising:
a first channel detecting at a first wavelength; and
a second channel detecting at a second wavelength;
wherein the apparatus substantially concurrently captures at least a first image of the optically active article through the first channel and a second image of the optically active article through the second channel

35-38. (canceled)

39. The apparatus of claim 34, wherein the first image is captured within 40 milliseconds or less from the capturing of the second image.

40-41. (canceled)

42. The method of claim 34, wherein information gleaned from the first image is used to facilitate processing of the second image.

43. The method of claim 34, wherein information gleaned from the second image is used to facilitate processing of the first image.

44. A method of reading optically active articles comprising:
providing a first optically active article that is non-retroreflective;
providing a second optically article that is retroreflective;
substantially simultaneously exposing the first and second optically active articles to radiation having a first wavelength and radiation having a second wavelength, the second wavelength being different from the first wavelength; and
substantially concurrently capturing an image of the first optically active article at the first wavelength and capturing an image of the second optically active article at the second wavelength.

45. The method of claim 44, wherein the first wavelength is within the visible spectrum and the second wavelength is within the infrared spectrum.
